(19) United States
(12) Patent Application Publication
(10) Pub. No.: US 2008/0014781 A1
(43) Pub. Date: Jan. 17, 2008

(54) Closed Housing for a Locking Element of a Plug-In Connection

(76) Inventors: Thomas Burk, Bad Liebenzell (DE); Gerald Schreiber, Randweil (AT)

Correspondence Address: K.F. ROSS P.C., 5683 RIVERDALE AVENUE, SUITE 203 BOX 900, BRONX, NY, 10471-0900, US

(21) Appl. No.: 11/791,010

(22) PCT Filed: Nov. 17, 2005
(86) PCT No.: PCT/EP05/12318

§ 371 Date: May 17, 2007

(30) Foreign Application Priority Data
Nov. 17, 2004 (DE) 102004055540.0
Jun. 29, 2005 (DE) 102005030264.5

(51) Int. Cl. H01R 13/627; H01R 13/641

(52) U.S. Cl. 439/352

(57) ABSTRACT

The invention concerns a locking device (5) for a connector or a socket (1) of a plug-in connection, said device being arranged on a housing (2) of the connector or of the socket (1) and comprising stop means with or without locking element which can be placed in at least one locking position above the plug-in zone (10). The invention is characterized in that the housing (2) is designed such that the stop means with or without locking element in its locking position is surrounded almost completely or completely by a partial zone of the housing (2).

The invention relates to a locking device for a plug or a socket of a plug-in connection according to the features of the preamble of claim 1.

Plug-in connections are known from the prior art (for example, EP 0 655 807 A2, EP 0 854 546 B1 [U.S. Pat. No. 6,022,238], U.S. Pat. No. 5,803,651, DE 195 25 413 A1 [U.S. Pat. No. 5,605,472], DE 196 21 762 A1 [U.S. Pat. No. 5,681,1781]) in which a plug and a socket may be joined together to form a plug-in connection. To prevent the plug-in connection from coming apart, locking devices are known which may be brought into at least one locking position after the plug and socket are joined so that the plug and socket cannot be separated during use of the plug-in connection, in particular for automotive applications. To ensure electrical contact for the plug-in connection, the locking device is particularly designed so that it cannot be brought into the locking position until the plug and socket have been completely joined. To ensure this, it is important that the locking device can be easily brought into the locking position. In the locking devices known from the prior art, optional locking elements are known which may be further displaced and which are provided on a housing for the plug or socket, that location being provided with a plug-in region for the locking element in which the locking element may be inserted to assume the locking position. The locking device in addition to the plug-in region and the optional overall system of the locking element on the housing for the plug or socket has the disadvantage that it is largely open, thus permitting contaminants (such as particles generated during the housing manufacturing process, or paints, when the housing for the plug or socket is provided with a coat of paint, or the like) to enter, with the disadvantageous result that the latch element for the locking device in addition to the optionally provided locking element either can no longer be inserted into the plug-in region, or, if it still functions at all, cannot be brought into its important locking position. As a result, the latch element cannot lock with the mating connector, or the locking element may, for example, fall out if it is placed in the plug-in region in a so-called prelocking position, or it may not be possible to completely lock the plug-in connection when the locking element is not in its at least one locking position (also referred to as the final locking position). Finally, a locking device for a plug or a socket of a plug-in connection is known from DE 103 41 136 which properly performs the important locking function, the locking element designed as a sliding element being first brought into a prelocking position in the plug-in region after manufacture of the plug or socket, and not being moved into its final locking position until the plug and socket of the plug-in connection have been completely joined. Here as well, however, the locking element for the most part is open at the housing for the socket or the plug, thus allowing contaminant particles to penetrate. In addition, this locking element is designed in such a way that it produces an audible locking sound when it is brought from its prelocking position to its final locking position. In an open configuration of the locking element, however, this locking sound radiates into the surrounding space so that it is no longer perceivable, particularly when the movement of the locking element from its prelocking position to its final locking position takes place in a loud production room. Variants of this housing without these additional locking elements are also conceivable. In such variants, for housings for the plug or socket which are already provided with a coat of paint, the latch element may be fixed in such a way that complete joining of the socket and plug is not possible, or may be achieved only with great difficulty. Actuation of the latch element for unlocking such a problematic plug-in connection is then virtually impossible.

The object of the invention, therefore, is to provide a locking device for a plug or a socket of a plug-in connection by means of which the plug and the socket of the plug-in connection are securely joined, and the above-described disadvantages are avoided, and optionally the possibility is provided for omitting additional locking elements.

The invention provides that the housing for the plug or the socket is designed such that the latch element, optionally with or without a locking element, in its locking position is completely or almost completely enclosed by a part of the housing. The part of the housing for the plug or the socket thus protects the latch element, optionally with or without a locking element, from external environmental conditions, in particular from contamination from loose particles or paint applications. Paint applications are used, for example, when the plug or the socket after being cabled has been installed on an add-on part (a motor, for example) of a vehicle, but has not yet been joined to form the complete plug-in connection. In other words, the plug, for example, after cabling and installation is first painted, and only then joined with the socket to form the overall plug-in connection. As a result of the almost complete encapsulation of the latch element, optionally with or without a locking element, in such a case paint cannot penetrate into the plug-in region, and therefore the latch element, with or without a locking element, may be brought into its locking position in a proper and operationally reliable manner when the plug and socket are joined together. A further advantage of the almost complete encapsulation of the latch element, optionally with or without a locking element, is that, as a result of the intentional design of the latch element, the locking sound produced upon reaching the locking position, in particular the final locking position, is more noticeable since it no longer radiates in an uncontrolled manner in the surrounding space, but instead is emitted in a concentrated manner through the plug-in region and/or some other small opening in the part of the housing, and is thus much more audible. This allows the additional locking element to be optionally omitted, since the satisfactory completion of the plug-in procedure is clearly audible. Economical plug-in connector designs and reduced handling costs may be achieved as a result. The necessity for using plug-in connections with an additional locking element is thus reduced to a few safety-related applications.

The locking device according to the present invention does not necessarily involve the design of the latch element, optionally with or without a locking element as such, or the means on the housing for the plug or socket which cooperates therewith. Thus, for example, the designs of the latch element, optionally with or without a locking element, known from the prior art may be used when just the locking element in its locking position is almost completely enclosed by the part of the housing. Use of the locking element known from DE 103 41 136 is particularly advantageous since this locking element has numerous advantages. For one, it is easy to manufacture, and in particular the housing for the plug or the socket may be easily produced by injection molding. In addition, the known locking element is designed as a sliding element, and is inserted into the plug-in region and first fixed in a prelocking position. This process is generally carried out by the manufacturer of the plug or the socket, so the plug or socket prepared in this manner can be supplied on a cable assembly which provides the plug or the socket with contacts and cables. After this preparation, the cable bundle thus assembled may be delivered to an automobile manufacturer, for example, and installed. Since the installation, i.e. the joining of the plug and socket to form a plug-in connection, takes place on the automobile manufacturing assembly line, it is important to ensure that the plug and socket are completely joined in order to prevent malfunction of the plug-in connection. To this end, the appropriately prepared plug or socket offers the advantage that a locking sound is clearly audible during the plug-in procedure, which makes the use of an additional locking element only optional. In such cases, however, after the plug and socket are joined together the locking element is pushed into its final locking position, which according to the present invention is easily performed since, on account of the almost complete encapsulation, the motion of the locking element from the prelocking position to its final locking position is not hindered by contaminant particles, and the locking sound is clearly audible when the final locking position is reached.

One illustrated embodiment of a socket (or alternatively, a plug) of a plug-in connection, to which the invention, however, is not limited, is described below and explained with reference to the figures in which:

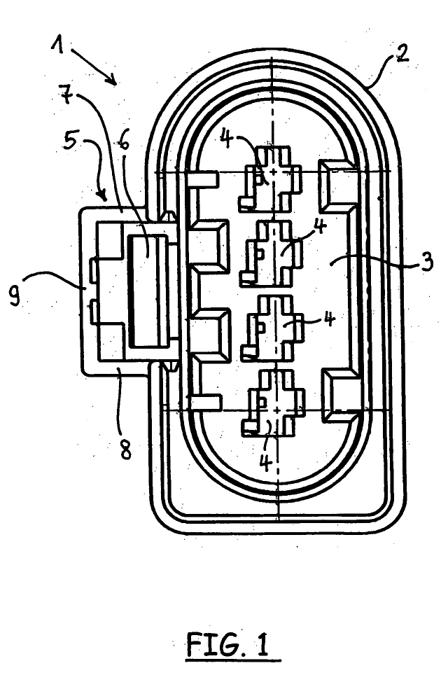

FIG. 1 shows an end face of a socket;

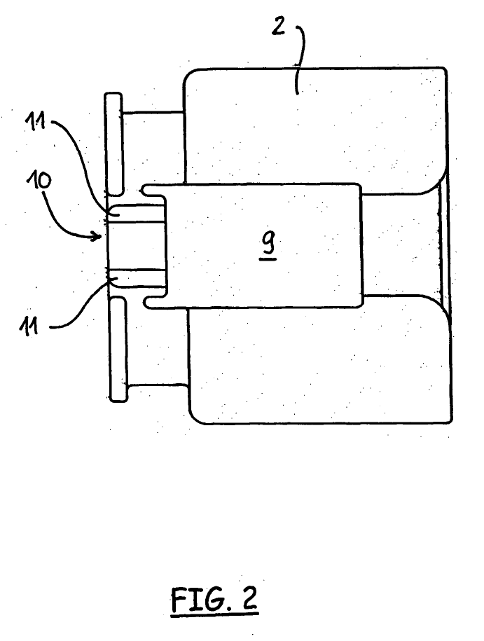

FIG. 2 shows a top view of the socket housing, with a view of the locking element located there;

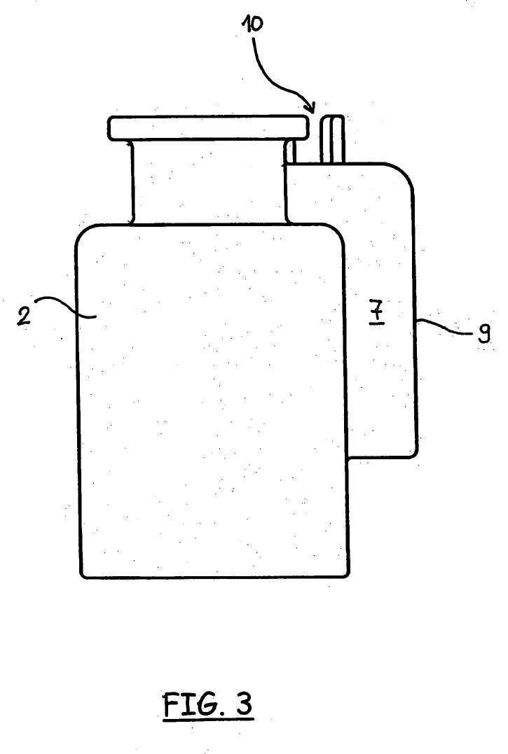

FIG. 3 shows a side view of the socket housing;

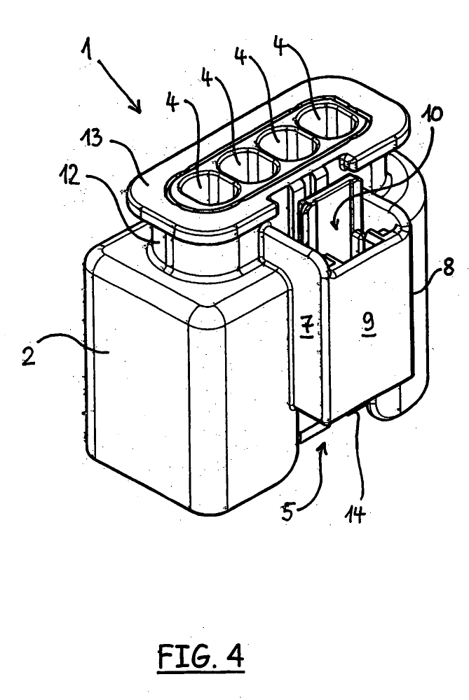

FIG. 4 shows a three-dimensional view of the socket housing with a view of the cable exit side;.

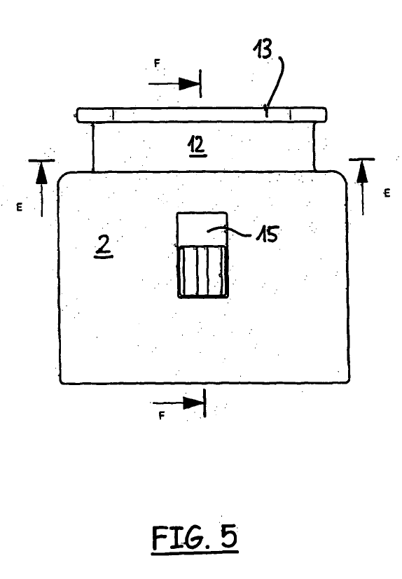

FIG. 5 shows a top view of the socket housing with a view of the side opposite from the locking element; and

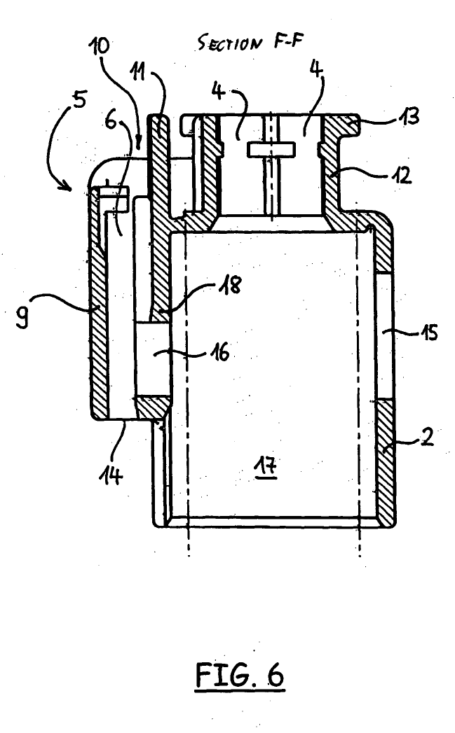

FIG. 6 shows a section F-F of the socket housing according to FIG. 5.

FIG. 1 shows in detail an end face of a socket 1 of a plug-in connection. Insofar as the description of the locking device according to the invention in the preceding or following discussion refers to a socket, the same applies for a plug. In addition, it is assumed that the locking device provided on the plug or the socket corresponds to analogous means provided on the plug or socket to be used.

The socket 1 has a housing 2 which accommodates an insert 3 having seats 4 for contacts (socket element), not illustrated here. The housing 2 and insert 3 are designed as separate components or as one piece. The seats 4 for the contacts are illustrated here in a single row, although more than four or less than four seats 4 may be provided. An application having two or more rows of sockets (plugs) is also possible.

On one side of the approximately rectangular housing 2 a locking device 5 is provided that has a design as known from DE 103 41 136 and described therein. The locking device 5 has a recess 6 in which a locking element (in the form of a sliding element, for example), not illustrated, is or may be inserted. In the region of the locking device 5 the housing 2 has side walls 7 and 8 which are connected by a continuous cover 9. The side walls 7 and 8 and cover 9 thus form a part of the housing 2 by means of which a latch element 18 (also see FIG. 6) as well as an optionally provided locking element (not illustrated) in its locking position are almost completely enclosed.

The invention is further explained with reference to FIG. 2, which shows a top view of the housing 2 for the socket 1 with a view of the locking device 5 located there. It is seen that a plug-in region 10 for the locking element is provided on one side of the housing 2, and guide bars 11, for example, are provided as a guide for insertion of the locking element into the plug-in region 10 (and thus into the recess 6). Here as well, it is clear that the cover 9 almost completely encloses the recess 6 in which the latch element, optionally with or without a locking element, is subsequently provided. The housing 2 for the socket 1 may be manufactured in a particularly advantageous manner in a plastic injection-molding process, the outer surfaces of the housing 2 being formed by injection-molded halves, and the inner surfaces may be shaped by removable mold cores (casting tools).

FIG. 3 illustrates a side view of the housing 2 for the socket 1, once again showing the side wall 7 (and the side wall 8, concealed) as well as the cover 9.

FIG. 4 shows a three-dimensional view of the housing 2 for the socket 1 with a view of the cable exit side on which an annular collar 12 and an adjoining rim 13 are provided. Shown once again on one side of the housing 2 is the locking device 5 comprising the plug-in region 10, the side walls 7 and 8, and the cover 9. When the locking element (not illustrated here) is inserted into the plug-in region 10 the recess 6 is protected in advance from contaminants, and subsequently the locking element inserted at that location in its locking position is also protected from mechanical influences. It is particularly advantageous for a small part of the housing 2 which almost completely encloses the locking element to remain open during (and optionally also after) insertion, so that the locking sound is clearly audible when the locking element has reached its locking position (final locking position). For this purpose, at the end of the locking device 5 an end region 14 is provided which is open or which has a small opening. After the locking element is inserted, this end region 14, which is open or which has an opening, may be closed by an additional means or also by the locking element itself.

In the event that a locking element is not required, a variant is also possible having higher side walls 7 and 8 and a cover 9, so that the latch element 18 is better protected. In this manner the advantages with respect to the above-mentioned risk of contamination and damage are further enhanced.

FIG. 5 shows a top view of the housing 2 for the socket 1 on the side opposite the locking element 5. The housing 2 is seen to have an aperture 15 that is necessary for guiding a die part through during injection molding of the housing 2, in order to produce the shape of the aperture 16 in the locking device 5. This is because this aperture 16 is no longer accessible to the die part since the cover 9 must likewise be produced by injection molding. Optionally, a design without the aperture 15 is also possible when use is made of the corresponding tool engineering possibilities. If the aperture 15 is provided, consideration may be given to closing this aperture afterward, if necessary.

FIG. 6 shows a section F-F of the housing 2 for the socket 1 according to FIG. 5. In addition to the elements shown in the previous figures and provided with identical reference numerals, in FIG. 6 reference numeral 16 denotes an additional aperture, located approximately opposite the aperture 15, and reference numeral 17 denotes a seat for a plug for the socket illustrated here. The aperture 16 is necessary so that, for example, a locking hook (not illustrated) for the plug inserted into the seat 17 may engage in the aperture in order to accommodate an illustrated latch element 18 (the edge of the aperture 16 or an additional part, for example), which is initially in a starting position, so that the latch element can be brought from this starting position into its final locking position by pushing it into the socket 1. It is shown here that the end region 14 of the locking device 5 is open so that the locking sound upon reaching the final locking position is concentrated and therefore clearly audible. It is also shown once again that the housing 2 and the additional cover 9 almost completely enclose the latch element and the optionally provided locking elements which are located in the recess 6. It is advantageous for the housing 2 to have the aperture 16 on the side on which the locking device 5 is provided, and for the aperture 15, which is at least the same size or larger, to be provided on approximately the opposite side so that a mold part of simple design may be guided through the aperture 15 and the aperture 16 during manufacture of the housing 2 in order to shape, at least partially, the inner surface of the recess 6. In the event that the cover 9 is not manufactured in one work step during the injection molding of the housing 2, but instead is attached later, the cover may be implemented by use of various joining methods, in which case the aperture 15 may be omitted.

It is also possible to implement the aperture 16 by use of appropriate tool engineering measures without the need for the aperture 15.

List of Reference Numerals

1. Socket

2. Housing

3. Insert

4. Seat

5. Locking device

6. Recess

7. Side wall

8. Side wall

9. Cover

10. Plug-in region

11. Guide bars

12. Collar

13. Border

14. End region

15. Aperture

16. Aperture

17. Seat

18. Latch element

1. A locking device for a plug or a socket of a plug-in connection which is provided on a housing for the plug or the socket and comprising latch element, optionally with or without a locking element, which may be placed in at least one locking position via a plug-in region wherein the housing is designed such that the latch element, with or without a locking element, in its locking position is completely or almost completely enclosed by a part of the housing.

2. The locking device according to claim 1 wherein the housing has two side walls and a continuous cover which extends from the one side wall to the other side wall as protection for the latch element and for forming a recess for the optionally usable locking element, below which the locking element is located in its locking position.

3. The locking device according to claim 1 wherein the housing has an aperture on the side on which the locking device is located, and has an aperture of at least the same size approximately on the opposite side.

4. The locking device according to claim 1 wherein the housing has an aperture on the side on which the locking device is located, and on the opposite side has no aperture.

5. The locking device according to claim 1 wherein the housing has an aperture on the side on which the locking device is located, and on the opposite side likewise has a locking device which also is provided with an aperture.

6. The locking device according to claim 3 wherein the locking element may be inserted into the recess and at that location brought into a prelocking position, and cannot be brought from the prelocking position into a final locking position until a plug or socket inserted into a seat of the housing actuates the locking element, and pressure is then manually applied to the locking element.

7. The locking element according to claim 2 wherein the recess is almost completely enclosed in its end region.

8. The locking element according to claim 2 wherein a latch element is provided in the recess which corresponds to the detent elements of the locking element in order to fix the locking element in the locking position, in particular in a final locking position and a prelocking position.
